(19) United States
(12) Patent Application Publication
(10) Pub. No.: US 2016/0085667 A1
(43) Pub. Date: Mar. 24, 2016

(54) SPI ROM WITH BUILT-IN MASK ROM FOR BIOS

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventor: HUNG-CHI HUANG, New Taipei (TW)

(21) Appl. No.: 14/510,933

(22) Filed: Oct. 9, 2014

(30) Foreign Application Priority Data
Sep. 22, 2014 (TW) 103132685

(51) Int. Cl. G06F 12/02; G06F 13/16; G06F 9/44; G06F 13/42

(52) U.S. Cl. CPC G06F 12/0238; G06F 13/4282; G06F 13/16; G06F 9/4406; G06F 2212/202

(57) ABSTRACT

A serial peripheral interface (SPI) includes a mask read only memory (ROM). The mask ROM stores a basic input/output system (BIOS) boot block so that the BIOS boot block is protected from being compromised.

### FIELD

The subject matter herein generally relates to using mask read only memory (ROM) for protecting basic input/output system (BIOS).

### BACKGROUND

In electronic devices using BIOS to boot operating systems of the devices, running the BIOS during the booting process can encounter issues due to data corruption caused by damaged or modified BIOS, sudden power interruption, or other reasons. Therefore, better protection of the BIOS is needed.

### BRIEF DESCRIPTION OF THE DRAWINGS

Implementations of the present technology will now be described, by way of example only, with reference to the attached figures, wherein:

FIG. 1 is a diagrammatic view of a SPI memory with a mask ROM, in accordance with an embodiment;

FIG. 2 is another diagrammatic view of a SPI memory with a mask ROM, wherein a BISO region is stored in the SPI memory and a BIOS boot block is stored in the mask ROM, in accordance with an embodiment;

FIG. 3 is a diagrammatic view showing a device using a SPI memory with a mask ROM to store a BIOS; and

FIG. 4 is a flowchart showing a process of booting BIOS using the SPI memory of FIG. 1 or FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “comprising,” when utilized, means “including, but not necessarily limited to”; it specifically indicates open-ended inclusion or membership in the so-described combination, group, series and the like.

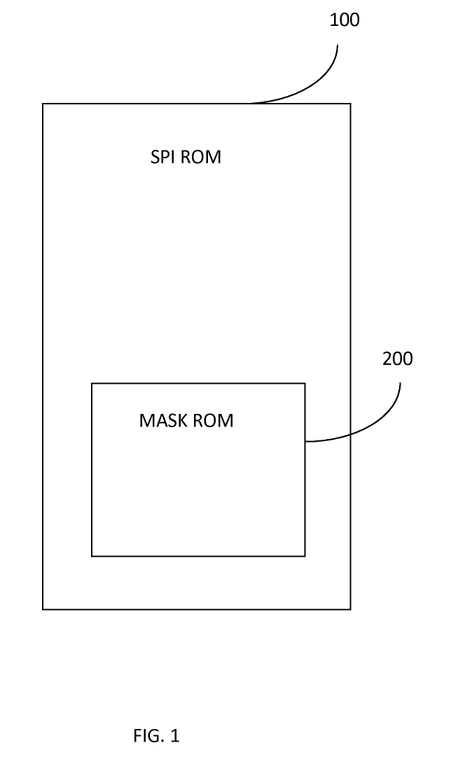

The present disclosure is described in relation to the accompanying FIGS. 1-4.

FIG. 1 illustrates a SPI memory 100 with a mask ROM 200. In this embodiment, the SPI memory is a ROM and the mask ROM 200 is built within the SPI ROM 100. The mask ROM 200 can be coupled to the SPI memory. The mask ROM 200 provides protection, such as write protection, for software stored within it. This way the software is protected against malicious hacking, computer virus, unexpected power interruption, and other damaging factors.

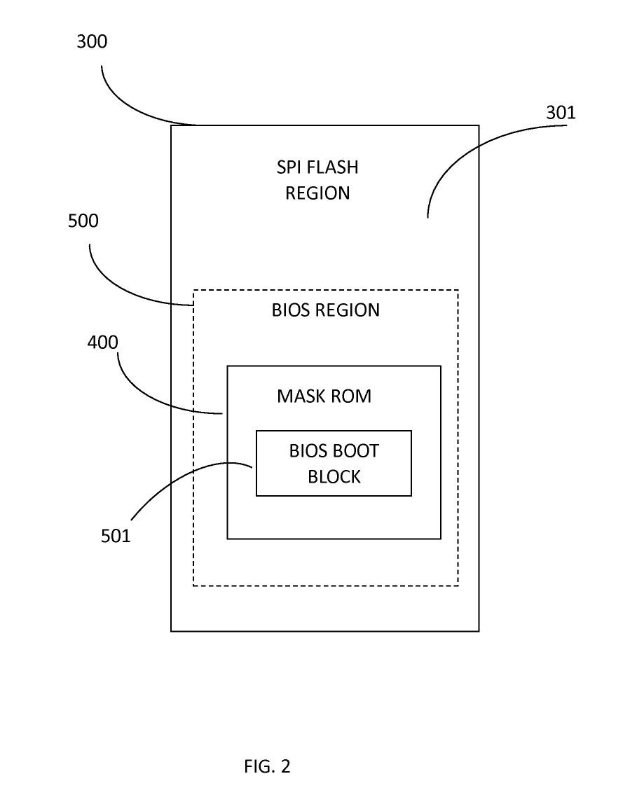

FIG. 2 illustrates an embodiment of a SPI memory 300 which includes a mask ROM 400. The SPI memory has a flash region 301, the flash region 301 has a BIOS region 500 to store a BIOS which includes a BIOS boot block 501 stored inside the mask ROM 400 to protect the BIOS boot block 501 against data corruption, and a main BIOS, or rest of the BIOS, stored outside the mask ROM 400 and in the BIOS region 500.

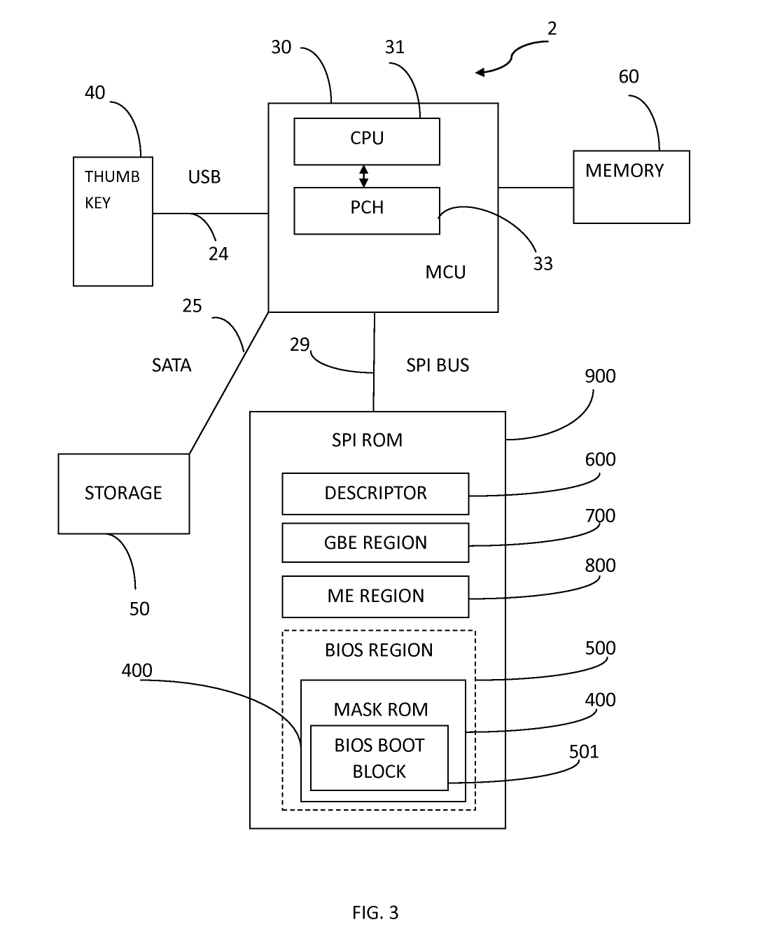

FIG. 3 illustrates, via an embodiment, an electronic device 2 using a SPI ROM 900 with the mask ROM 400 built inside it. The device 2 include micro controller unit (MCU) 30. The MCU 30 has a central processing unit (CPU) 31 and a platform controller hub (PCH) 33, coupled to the CUP 31. A memory 60 is coupled to the MCU 30. A universal serial bus (USB) connection 24 is provided for connecting the MCU 30 to a thumb key 40 for the purpose of BIOS recovery. The thumb key 40 can contain a BIOS image file for reflashing the BIOS. Storage 50, such as a hard disk drive, can be provided and coupled to the MCU 30 via a connection, such as a SATA connection cable. The storage 50 can contain a BIOS image for reflashing the BIOS in case of data corruption of the BIOS.

The SPI ROM 900 is coupled to the MUC 30 via a SPI bus 29, and can have a descriptor region 600, a gigabit Ethernet (GBE) region 700, a management engine (ME) region 800 and the BIOS region 500. The BIOS are stored in the BIOS region 500, where the BIOS boot block 501 of the BIOS is stored in the mask ROM 400 for write protection.

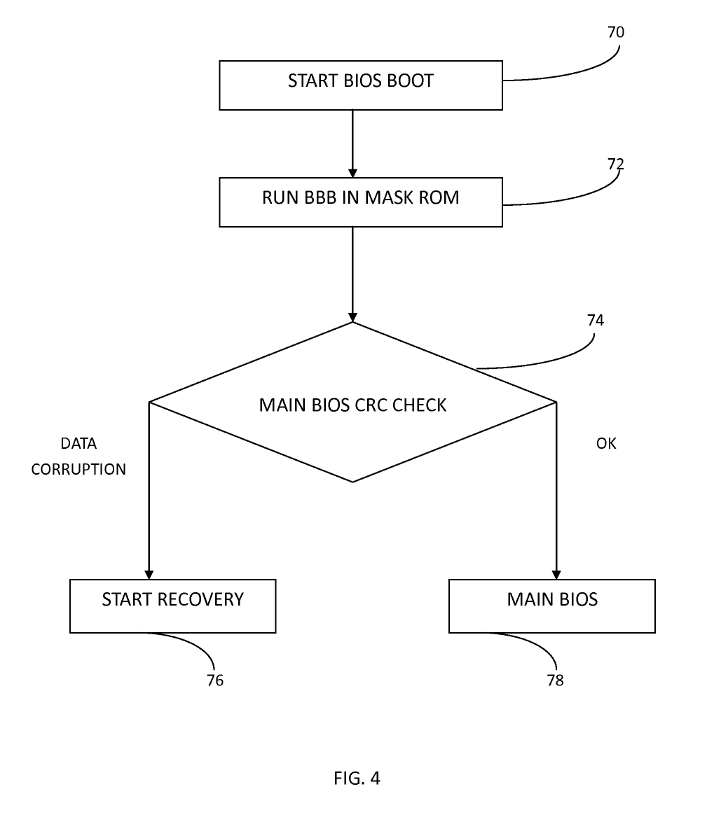

Referring to FIG. 4, a flowchart of booting the BIOS stored in the SPI memories 100, 300, or 900 (not shown) is presented in accordance with an example embodiment which is being thus illustrated. The example process is provided by way of example, as there are a variety of ways to carry out the method. The process described below can be carried out using the configurations illustrated in FIGS. 1 to 3, for example, and various elements of these figures are referenced in explaining example method. Each block shown in FIG. 4 represents one or more processes, methods or subroutines, carried out in the exemplary process of FIG. 4. Additionally, the illustrated order of blocks is by example only and the order of the blocks can change according to the present disclosure. The exemplary process can begin at block 70.

At block 70, booting the BIOS is stared, by, for example, supplying power to the device 2 (as shown in FIG. 3) to cause the BIOS stored in the SPI ROM 900 to be run. In block 72, the BIOS boot block stored in the mask ROM 200 or in mask ROM 400 is first executed. At next stage in block 74, an integrity check of the main BIOS stored in the BIOS region 500 to make sure that the BIOS data is not corrupt. The integrity check can be a cyclic redundancy check (CRC) for the main BIOS stored outside the mask ROM 400. When the result of the integrity check in block 74 turns to be good, the main BIOS is be executed in block 78 following a normal booting of the BIOS. However, when the result of the integrity check in block 74 is bad, i.e., the main BIOS has been damaged or corrupted, then the recovery of the BIOS in block 76 will be performed. The recovery can be done by reflashing the BIOS using BIOS data saved in the thumb key 40 or in the storage 50, which are connected to the device 2.

The embodiments shown and described above are only examples. Many details are often found in the art such as the other features of a SPI memory containing a BIOS. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A serial peripheral interface (SPI) memory, comprising:
a mask read only memory (ROM).

2. The SPI memory of claim 1, wherein the mask ROM stores a basic input/output system (BIOS) boot block of a BIOS.

3. The SPI memory of claim 2, wherein a main BIOS of the BIOS is stored outside the mask ROM.

4. The SPI memory of claim 1, wherein the SPI memory is a SPI ROM.

5. The SPI memory of claim 1, wherein the mask ROM is a built-in mask ROM.

6. An electronic device, comprising:
a central processing unit (CPU);
a platform controller hub (PCH), coupled to the CPU; and
a serial peripheral interface (SPI) memory, coupled to the PCH and comprising:
a mask read only memory (ROM).

7. The electronic device of claim 6, wherein the mask ROM stores a basic input/output system (BIOS) boot block of a BIOS.

8. The electronic device of claim 7, wherein a main BIOS of the BIOS is stored outside the mask ROM.

9. A method for booting a basic input/output system (BIOS), comprising:
providing a serial peripheral interface (SPI) memory comprising a mask read only memory (ROM), wherein the SPI memory stores a main BIOS of a BIOS, and the mask ROM stores a BIOS boot block of the BIOS; and
running the BIOS boot block from the mask ROM.

10. The method of claim 9, further comprising:
checking integrity of the main BIOS by running the BIOS boot block.

11. The method of claim 10, further comprising:
running the main BIOS when the result of the integrity check is good.

12. The method of claim 10, further comprising:
starting recovery for the BIOS when the result of the integrity check is bad.
